(19) United States
(12) Patent Application Publication
(10) Pub. No.: US 2003/0195283 A1
(43) Pub. Date: Oct. 16, 2003

(54) Composition for forming overcoat layer for organic photoreceptor and organic photoreceptor employing overcoat layer prepared from the composition

(75) Inventors: Nam-Jeong Lee, Seoul (KR); Kyung-yol Yon, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG Electronics Co., Ltd., Suwon-city (KR)

(21) Appl. No.: 10/412,213

(22) Filed: Apr. 14, 2003

(30) Foreign Application Priority Data
Apr. 16, 2002 (KR) 2002-20595

(51) Int. Cl. G03G 5/147; C08K 5/24

(52) U.S. Cl. 524/261; 430/66; 430/132; 524/589

(57) ABSTRACT

A composition to form an overcoat layer for an organic photoreceptor includes an organic silane compound, an alcohol-soluble polymer, and a solvent. When the composition is used in forming an overcoat layer, it is not necessary to coat a primer or an adhesive layer to improve adhesion, thus simplifying a coating process and reducing the cost required in forming additive layers. Also, since the organic photoreceptor has a high durability, the life characteristics of electrophotographic organic photoreceptor may be increased. Further, in an electrophotographic imaging process, a decrease in charge potential and a rise in the residual potential can be reduced, thus improving the life characteristic of the organic photoreceptor.

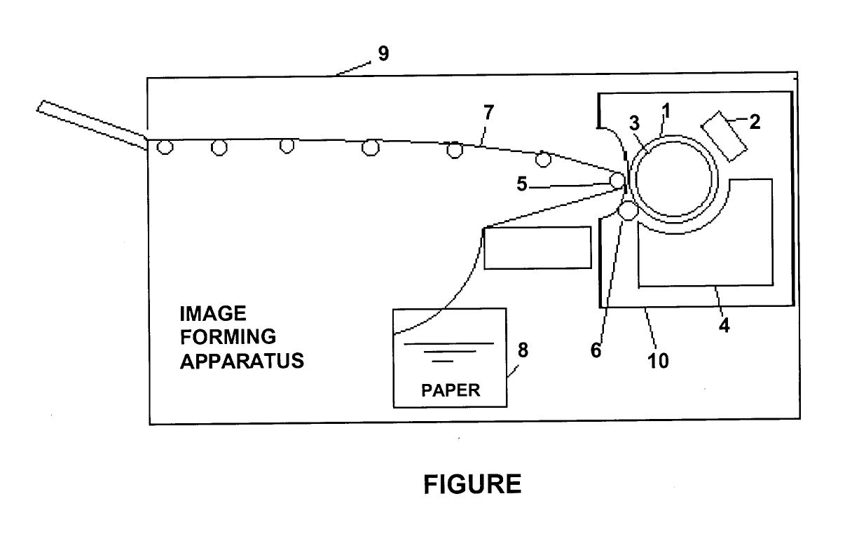

### CROSS-REFERENCE TO RELATED APPLICATIONS

This application claims the benefit of Korean Application No. 2002-20595, filed Apr. 16, 2002, in the Korean Intellectual Property Office, the disclosure of which is incorporated herein by reference.

### BACKGROUND OF THE INVENTION

1. Field of the Invention

The present invention relates to a composition to form an overcoat layer for an organic photoreceptor and an organic photoreceptor employing an overcoat layer prepared from the composition. More particularly, the invention relates to a composition to form an overcoat layer constituting an outermost layer of an organic photoreceptor to form an electrophotographic image, and an organic photoreceptor having improved life characteristics by increasing wear resistance of the overcoat layer by employing the overcoat layer prepared from the composition.

2. Description of the Related Art

In electrophotography, an organic photoreceptor includes a photosensitive layer formed on a conductive base and is in the form of a plate, disk, sheet, belt, or drum.

The principles of electrophotographically forming an image are described briefly. First, the surface of the organic photoreceptor is electrostatically uniformly charged and irradiated with a laser beam. Positive and negative charges are generated at portions into which a laser beam is irradiated and migrate to the surface. As the surface charges are neutralized, the surface potential in an exposed area is changed so that a latent image is formed.

Thereafter, when the latent image is developed with toner, a visible image is formed on the surface of the organic photoreceptor. The formed image is transferred to the surface of a receiver, such as paper.

Both single layer and multilayer photoconductive elements have been used. In the single layer embodiment, a charge transport material and a charge generating material are combined with a polymeric binder and then coated on the electrically conductive base. In the multilayer embodiment, the charge transport material and the charge generating material are in the form of separate layers, each of which can optionally be combined with a polymeric binder, coated on the conductive base. Two arrangements are possible. In one arrangement (the “dual layer” arrangement), the charge generating layer is coated on the conductive base, and the charge transport layer is coated on top of the charge generating layer. In an alternate arrangement (the “inverted dual layer” arrangement), the order of the charge transport layer and the charge generating layer is reversed.

In both the single and multilayer photosensitive layers, the purpose of the charge generating material is to generate charge carriers (i.e., holes and electrons) upon exposure to light. The purpose of the charge transport material is to accept these charge carriers and transport them through the charge transport layer in order to discharge a surface charge on the photoconductive element.

In general, the photoreceptor wears easily due to friction against the toner, a roller or a cleaning blade during an imaging process, so that the thickness thereof decreases and the life thereof is shortened. For this reason, an overcoat layer is coated on the organic photoreceptor.

In manufacturing the overcoat layer of the organic photoreceptor, the use of silsesquioxane-based silicon hard-coat materials is disclosed in U.S. Pat. Nos. 6,187,491 and 5,731,117.

The silicon hard-coat materials have good wear resistance and are capable of easily introducing chemical functional groups and adjusting mechanical and electrical properties. Also, since alcoholic solvents used in forming an overcoat layer do not adversely affect a general organic photoreceptor, they are widely used as overcoat forming materials.

However, since such a silicon hard-coat material has weak adhesion to a photoreceptor so that it is easily peeled off or worn, it is necessary to form an adhesive layer or primer layer thereon.

Such an additional operation of forming the adhesive layer results in an increase in cost. Also, electrical characteristics of an organic photoreceptor, such as exposure potential or residual potential, are degraded.

### SUMMARY OF THE INVENTION

Additional aspects and advantages of the invention will be set forth in part in the description which follows and, in part, will be obvious from the description, or may be learned by practice of the invention.

The present invention provides a composition to form an overcoat layer for an organic photoreceptor with improved electrical properties while wear resistance and adhesion are enhanced, and an organic photoreceptor by which forming a separate adhesive layer is not necessary by employing an overcoat layer prepared from the composition.

In accordance with an aspect of the present invention, a composition to form an overcoat layer for an organic photoreceptor comprises an organic silane compound represented by Formula 1, an alcohol-soluble polymer, and a solvent:

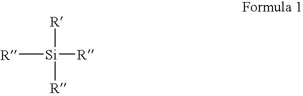

wherein R′ is at least one selected from the group consisting of a C₁-C₂₀ alkyl, phenyl, vinyl, methacryloxypropyl, aminopropyl, aminoethylaminopropyl, phenylaminopropyl, chloropropyl, mercaptopropyl, acryloxypropyl, 3-glycidoxypropyl, trifluoropropyl, heptadecafluorodecyl, and isocyanatopropyl group, and R″, which is a hydrolyzable functional group, is a C₁-C₂₀ alkoxy group or a halogen atom.

In accordance with another aspect of the present invention, an organic photoreceptor includes a conductive base, a photosensitive layer formed on the conductive base, and an overcoat layer formed on the photosensitive layer and having a product obtained by coating the overcoat layer forming composition.

### BRIEF DESCRIPTION OF THE DRAWINGS

These and/or other aspects and advantages of the present invention will become apparent and more readily appreciated from the following description of the embodiments, taken in conjunction with the accompanying drawing:

FIGURE is a block diagram of an embodiment of an organic photoreceptor cartridge/drum and an image forming apparatus in accordance with an embodiment of the organic photoreceptor of the present invention.

### DETAILED DESCRIPTION OF THE PREFERRED EMBODIMENTS

Reference will now be made in detail to the present preferred embodiments of the present invention, an example of which is illustrated in the accompanying drawing. The embodiment is described below in order to explain the present invention by referring to the figure.

The present invention provides an organic photoreceptor simultaneously using silsesquioxane which is a hydrolyzed and polycondensated product of an organic silane compound represented by Formula 1 and an alcohol-soluble polymer in forming an overcoat layer. If the overcoat layer is formed by using silsesquioxane and the alcohol-soluble polymer simultaneously, the operation of coating a primer or an adhesive layer, which is necessarily performed to overcome the weak adhesion of the overcoat layer, can be omitted, thus simplifying the process and preventing electrical properties of the organic photoreceptor from deteriorating due to an additional layer.

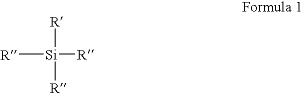

wherein R′ is at least one selected from the group consisting of a C₁-C₂₀ alkyl, phenyl, vinyl, methacryloxypropyl, aminopropyl, aminoethylaminopropyl, phenylaminopropyl, chloropropyl, mercaptopropyl, acryloxypropyl, 3-glycidoxypropyl, trifluoropropyl, heptadecafluorodecyl, and isocyanatopropyl group, and R″, which is a hydrolyzable functional group, is a C₁-C₂₀ alkoxy group or a halogen atom.

In R′ and R″ of Formula 1, examples of the C₁-C₂₀ alkyl group include methyl, ethyl, propyl and butyl group.

Examples of the organic silane compound of Formula 1 include one or more selected from the group consisting of 3-glycidoxypropyl trimethoxysilane (Z-6040; DOW CORNING, KBM 403; SHIN-ETSU), methyltrimethoxysilane (Z-6070; DOW CORNING, KBM 13; SHIN-ETSU), methacryloxypropyltrimethoxysilane (Z-6030, KBM502), aminopropyltrimethoxysilane (Z-6011, KBM903), aminoethylaminopropyltrimethoxysilane (KBM603), trifluoropropyltrimethoxysilane (KBM7103), heptadecafluorodecyltrimethoxysilane (KBM7803), isocyanatopropyltriethoxysilane (KBE9007), aminopropyltriethoxysilane (KBE903), and aminoethylaminopropyltriethoxysilane (KBE603).

The alcohol-soluble polymer is at least one selected from the group consisting of polyvinylbutyral, polyamide and polyurethane, and the amount thereof is in the range of 1 to 20 parts by weight based on 100 parts by weight of the organic silane compound represented by Formula 1. If the amount of the alcohol-soluble polymer is less than 1 part by weight, an adhesion enhancing effect of the polymer cannot be expected, even with the addition of the polymer. If the amount of the alcohol-soluble polymer is greater than 20 parts by weight, advantages of the alcohol-soluble polymer from use of silsesquioxane, including wear resistance, are not exerted.

The polyvinylbutyral resin is represented by Formula 2

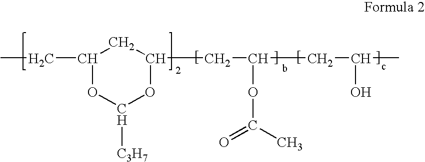

wherein a is 60 to 80 mol %, b is 0 to 10 mol %, and c is 0 to 40 mol %.

The weight average molecular weight of the polyvinylbutyral resin is preferably in the range of 40,000 to 120,000. If the weight average molecular weight of the polyvinylbutyral resin is out of the above range, coating of an overcoat layer forming composition is quite difficult to perform.

In the present invention, the solvent dissolves the organic silane compound of Formula 1 and the alcohol-soluble polymer. Useful examples thereof include a cosolvent of at least one alcoholic solvent selected from the group consisting of ethanol, butanol, methanol and isopropanol, and water. The amount of the solvent used is in the range of 150 to 900 parts by weight based on 100 parts by weight of solid content of the overcoat layer forming composition, that is, the sum of the amounts of the organic silane compound of Formula 1 and the alcohol-soluble polymer. The amount of water is preferably 5 to 30 parts by weight based on 100 parts by weight of the alcoholic solvent. If the amount of the solvent is greater than the above range, the excess gives rise to an undesirable coating capability of the composition, that is, the coating is too thin to serve as an overcoat layer. If the amount of the solvent is less than the above range, the shortage results in undesirable properties of the organic silane compound of Formula 1 and the alcohol-soluble polymer with respect to solubility.

The overcoat layer forming composition according to the present invention may further include a hydrolysis catalyst in an amount of 5 to 20 parts by weight based on 100 parts by weight of the organic silane compound of Formula 1. As described above, addition of the hydrolysis catalyst facilitates hydrolysis of the organic silane compound of Formula 1 and increases stability of the hydrolyzed and polycondensated product of the organic silane compound. Typical examples of the hydrolysis catalyst include acetic acid.

A method of manufacturing an electrophotographic organic photoreceptor using the overcoat layer forming composition according to the present invention is described below.

First, a photosensitive layer is formed on a conductive base. The photosensitive layer may be formed by sequentially stacking a charge transport layer containing a charge transport material, and a charge generating layer containing a charge generating material, or reversely stacking the layers. Otherwise, the photosensitive layer may have a single layered structure containing a charge transport material and a charge generating material.

The charge transport layer is formed by coating a composition including a charge transport material, a binder and an organic solvent, and drying the resultant structure. The charge generating layer is formed by coating a composition including a charge generating material, a binder and an organic solvent, and drying the resultant structure.

Examples of the charge transport material include a pyrazoline derivative, a fluorene derivative, an oxadiazole derivative, a stilbene derivative, a hydrazone derivative, a carbazole hydrazone derivative, polyvinyl carbazole, polyvinylpyrene and polyacenaphthylene. Examples of the charge generating material include a metal-free phthalocyanine (e.g., PROGEN 1x-form metal-free phthalocyanine, ZENECA, INC.), and metal phthalocyanine such as titanium phthalocyanine, copper phthalocyanine, oxytitanium phthalocyanine, or hydroxygallium phthalocyanine. The amounts of these materials are in the conventional range. In particular, the charge transport material is used in an amount of 35 to 65 parts by weight based on 100 parts by weight of the charge transport layer forming composition, and the charge generating material is used in an amount of 55 to 85 parts by weight based on 100 parts by weight of the charge generating layer forming composition.

The binder is capable of dissolving or dispersing the charge transport material or the charge generating material, and examples thereof include polyvinylbutyral, polycarbonate, polystyrene-co-butadiene, modified acryl polymer, polyvinylacetate, styrene-alkyd resin, soya-alkyl resin, polyvinylchloride, polyvinylidene chloride, polyacrylonitrile, polyacrylic acid, polyacrylate, polymethacrylate, styrene polymer, alkyd resin, polyamide, polyurethane, polyester, polysulfone, polyether and combinations thereof. In particular, polycarbonate and polyvinylbutyral are used in the present invention. The binder is used in an amount of 15 to 65 parts by weight based on 100 parts by weight of the charge generating layer forming composition or the charge transport layer forming composition.

Examples of the solvent forming the charge transport layer forming composition and the charge generating layer forming composition include tetrahydrofuran, methylene chloride, chloroform, dichloroethane, trichloroethane, chlorobenzene, and acetate-based solvent, and the amount of the solvent is in the range of 70 to 99 parts by weight based on 100 parts by weight of solid content of the charge generating layer forming composition or the charge transport layer forming composition.

The coating method of the charge generating layer forming composition and the charge transport layer forming composition is not particularly limited, but ring coating or dip coating is preferred in the case where the conductive base is in the form of a drum.

As described above, after forming a photosensitive layer on the conductive base, the overcoat layer forming composition according to the present invention is coated on the photosensitive layer and thermally treated to form an overcoat layer, thus completing the electrophotographic photoreceptor according to the present invention. The thermal treatment is preferably performed at a temperature in the range of 80 to 140° C., more preferably 100 to 130° C.

When the organic silane compound of Formula 1 is hydrolyzed in the composition in the presence of water, it exists in a state of a silanol group (Si—OH) or a partially hydrated and polycondensated state, and is then subjected to hydrolysis and polycondensation during thermal treatment after coating, thus forming silsesquioxane. The alcohol-soluble polymer and the polyvinylbutyral resin may participate in the reaction of forming silsesquioxane according to a presence or an absence of a functional group existing in the polymer, e.g., the hydroxy group. Thus, the finally formed overcoat layer may include silsesquioxane which is a hydrolyzed and polycondensated product of the organic silane compound Formula 1 and alcohol-soluble polymer, or may include a crosslinked product of silsesquioxane and the alcohol-soluble polymer.

The overcoat layer forming composition may be coated by spin coating, dip coating or ring coating. Ring coating or dip coating is preferred when the conductive base is in the form of a drum.

In the organic photoreceptor according to the present invention, the overall thickness of the photosensitive layer is in the range of 5.1 to 26 μm. Generally, the charge generating layer has a thickness of 0.1 to 1.0 μm, the charge transport layer has a thickness of 5 to 25 μm, and the conductive base, in particular, the drum, has a thickness of 0.5 to 2 mm. The overcoat layer has a thickness of 0.1 to 10 μm. If the thickness of the overcoat layer is less than 0.10 μm, the ability of the overcoat layer to protect underlying layers is weak. If the thickness of the overcoat layer is greater than 10 μm, the electrical properties of the overcoat layer undesirably deteriorate. For example, the exposure potential of the overcoat layer may increase.

The organic photoreceptor according to the present invention may further include additional layers. Such additional layers are generally known layers, for example, a charge blocking layer. The charge blocking layer may be formed between the conductive base and the charge transport layer, improving adhesion therebetween.

In the electrophotographic imaging process using the organic photoreceptor, dry or liquid toner can be used. In electrophotography, when the organic photoreceptor for a conventional dry-type toner is applied to a liquid toner, it contacts a paraffinic solvent, which is one of main components of the liquid toner, resulting in cracking or crazing, or dissolving some components of the organic photoreceptor.

On the other hand, since the organic photoreceptor according to the present invention has a high resistance to a paraffinic solvent, it can be advantageously used in an electrophotographic imaging process using a liquid toner, and the above-described problems can be avoided.

The, the present invention is described below in greater detail with reference to the following examples. The following examples are for illustrative purposes and are not intended to limit the scope of the invention.

### EXAMPLE 1

2.05 g methyltrimethoxysilane (Z-6070, DOW CORNING), 0.88 g glycidoxypropyltrimethoxysilane (Z-6070, DOW CORNING), 0.075 g polyvinylbutyral (BM-S, SEKISUI CO., Japan), 0.29 g acetic acid, 1.01 g water and 5.7 g isopropanol were well mixed to give a transparent solution of an overcoat layer forming composition.

The composition was coated on a negatively charged photoreceptor drum (SAMSUNG ELECTROMECHANICS CO., Korea) using a ring coater, and heat-treated at 130° C. for 10 minutes to form an overcoat layer. As a result, a complete organic photoreceptor was obtained. Here, the coating speed was 100 mm/min.

### EXAMPLE 2

An overcoat layer was formed in the same manner as in Example 1 except that Z-6070 (DOW CORNING), Z-6040 ( DOW CORNING), BM-S (SEKISUI CO., Japan), acetic acid, water and isopropanol were used in amounts of 1.89 g, 0.81 g, 0.3 g, 0.27 g, 0.93 g and 5.8 g, respectively, thus obtaining a complete organic photoreceptor.

### COMPARATIVE EXAMPLE

An overcoat layer was formed in the same manner as in Example 1 except that 2.1 g Z-6070 (DOW CORNING), 0.9 g Z-6040 (DOW CORNING), 0.3 g acetic acid, 1.04 g water and 5.66 g isopropanol were well mixed to give a transparent solution of an overcoat layer forming composition, thus obtaining a complete organic photoreceptor.

Film states of organic photoreceptors employing overcoat layers prepared in Examples 1-2 and the Comparative Example, and the adhesive forces and the electrostatic properties of the overcoat layers were evaluated by the following methods. The results thereof are listed in Table 1.

Coating status of the organic photoreceptor: Before and after dipping in NORPAR 12 for 48 hours, the organic photoreceptors were visually evaluated to determine whether cracking or crazing occurred or not.

Adhesive force of the overcoat layer: Adhesive forces of the overcoat layers were evaluated using a 180° peel tester.

Electrostatic properties: Electrostatic properties of the organic photoreceptors were evaluated using PDT2000 (QEA CO.) while observing a change in the color of NORPAR 12 before and after dipping in NORPAR 12 for approximately 48 hours. Changes in the charge potential and the exposure potential were measured by repeating charge-exposure-erase cycling 100 times.

TABLE 1

| Evaluation | | | | Comparative |
|---|---|---|---|---|
| item | | Example 1 | Example 2 | Example |
| Charge | Before coating | 770 | 770 | 768 |
| potential | After coating | 770→731* | 796→775 | 766→723 |
| (V) | After dipping in | 770→751 | 778→756 | 784→732 |
| | NORPAR 12 | | | |
| Exposure | Before coating | 47 | 40 | 42 |
| potential | After coating | 47→52 | 43→51 | 61→149 |
| (V) | After dipping in | 54→63 | 60→63 | 71→138 |
| | NORPAR 12 | | | |

| | | | |
|---|---|---|---|
| Change in color of | Light yellow | None | Dark yellow |
| NORPAR 12 | | | |
| Adhesion | Good | Good | Easily |
| | | | peeled |
| | | | off |
| Coating status (Occurrence of | None | None | Severe |
| cracking) | | | |

*Charge-Exposure-Erase cycling: (1^{st} cycle) →(100^{th} cycle)

As shown in Table 1, in the organic photoreceptor prepared in Comparative Example, after dipping in NORPAR 12, severe cracking occurred to the surface of the overcoat layer, the charge potential considerably decreased, and the adhesion between an overcoat layer and a photosensitive layer was so ineffective that the overcoat layer was easily peeled off.

On the other hand, the organic photoreceptors prepared in Example 1-2 showed relatively good adhesion of each overcoat layer and good coating status, compared to that prepared in the Comparative Example. Also, even after dipping in NORPAR 12, no cracking occurred, and the color of NORPAR 12 was not considerably changed. However, in the case of Example 1, the color of NORPAR 12 changed slightly, which was due to dissolution of a trace amount of the components of the organic photoreceptor by the action of NORPAR 12, among other components, passing through the overcoat layer.

The present invention provides, among others, the following advantages.

First, the organic photoreceptor according to the present invention has enhanced wear resistance, leading to improved life characteristics.

Second, when silsesquioxane is used in forming an overcoat layer, it is not necessary to coat a primer or an adhesive layer, which is required for the purpose of improving adhesion thus simplifying a coating process and reducing the cost required in forming additive layers.

Third, in the electrophotographic imaging process, a decrease in the charge potential and a rise in the residual potential can be reduced, thus improving the life characteristic of the organic photoreceptor.

Fourth, since the organic photoreceptor has a high durability against liquid toner, in particular, a paraffinic solvent, the organic photoreceptor can be used advantageously in an electrophotographic imaging process using the liquid toner.

Fifth, since the viscosity of the overcoat layer forming composition according to the present invention is easily adjusted, a limitation in coating thickness can be overcome.

As shown in the FIGURE, the organic photoreceptor of the present invention may be utilized in an organic photoreceptor cartridge 10, an organic photoreceptor drum 3, or in an image forming apparatus 9. The organic photoreceptor cartridge 10 typically comprises an electrophotographic organic photoreceptor 1 and at least one of a charging device 2 that charges the electrophotographic organic photoreceptor 1, a developing device 4 which develops an electrostatic latent image formed on the electrophotographic organic photoreceptor 1, and a cleaning device 6 which cleans a surface of the electrophotographic organic photoreceptor 1. The organic photoreceptor cartridge 10 is capable of being attached to and detached from the image forming apparatus 9, and the electrophotographic organic photoreceptor 1 is described more fully above. The organic photoreceptor drum 3 for the image forming apparatus 9, generally includes a drum that is attachable to and detachable from the image forming apparatus and that includes a electrophotographic organic photoreceptor 1 installed thereon, wherein the electrophotographic organic photoreceptor 1 is described more fully above. Generally, the image forming apparatus 9 includes a photoreceptor unit (e.g., a organic photoreceptor drum 3), a charging device 2 which charges the photoreceptor unit, an imagewise light irradiating device/developer 4 which irradiates the charged photoreceptor unit with imagewise light to form an electrostatic latent image on the photoreceptor unit, a developing device which develops the electrostatic latent image with a toner to form a toner image on the photoreceptor unit, and a transfer device 5 which transfers the toner image onto a receiving material, wherein the photoreceptor unit comprises an electrophotographic organic photoreceptor 1 as described in greater detail above. In the embodiment shown in FIGURE, the paper from a paper supply unit 8 moves along the paper path 7.

Although a few preferred embodiments of the present invention have been shown and described, it would be appreciated by those skilled in the art that changes may be made in this embodiment without departing from the principles and spirit of the invention, the scope of which is define in the claims and their equivalents.

What is claimed is:

1. A composition to form an overcoat layer for an organic photoreceptor, the composition comprising an organic silane compound represented by Formula 1, an alcohol-soluble polymer, and a solvent: 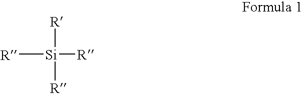
wherein R′ is at least one selected from the group consisting of a C₁-C₂₀ alkyl, phenyl, vinyl, methacryloxypropyl, aminopropyl, aminoethylaminopropyl, phenylaminopropyl, chloropropyl, mercaptopropyl, acryloxypropyl, 3-glycidoxypropyl, trifluoropropyl, heptadecafluorodecyl, and isocyanatopropyl group, and R″, which is a hydrolyzable functional group, is a C₁-C₂₀ alkoxy group or a halogen atom.

2. The composition of claim 1, wherein the alcohol-soluble polymer is at least one selected from the group consisting of polyvinylbutyral, polyamide and polyurethane, and the amount thereof is in the range of 1 to 20 parts by weight based on 100 parts by weight of the organic silane compound represented by Formula 1.

3. The composition of claim 1, wherein the organic silane compound represented by Formula 1 may be at least one selected from the group consisting of 3-glycidoxypropyl trimethoxysilane, methacryloxypropyltrimethoxysilane, aminopropyltrimethoxysilane, aminoethylaminopropyltrimethoxysilane, trifluoropropyltrimethoxysilane, heptadecafluorodecyltrimethoxysilane, isocyanatopropyltrimethoxysilane, 3-glycidoxypropyltriethoxysilane, methacryloxypropyltriethoxysilane, aminopropyltriethoxysilane, aminoethylaminopropyltriethoxysilane, trifluoropropyltriethoxysilane, heptadecafluorodecyltriethoxysilane, and isocyanatopropyltriethoxysilane.

4. The composition of claim 1, further comprising a hydrolysis catalyst in an amount of 5 to 20 parts by weight based on parts by weight of the organic silane compound represented by Formula 1.

5. The composition of claim 4, wherein the hydrolysis catalyst is acetic acid.

6. The composition of claim 1, wherein the solvent is a cosolvent of at least one alcoholic solvent selected from the group consisting of methanol, ethanol, isopropanol and butanol, and water, the amount thereof is in the range of 150 to 900 parts by weight based on 100 parts by weight of solid content of the overcoat layer forming composition, and the amount of water is in the range of 5 to 30 parts by weight based on 100 parts by weight of the alcoholic solvent.

7. An organic photoreceptor comprising:
a conductive base;
a photosensitive layer formed on the conductive base; and
an overcoat layer formed on the photosensitive layer and having a product obtained by coating an overcoat layer forming composition comprising an organic silane compound represented by Formula 1, an alcohol-soluble polymer, and a solvent, and thermally treating the same: 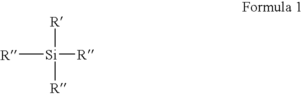
wherein R′ is at least one selected from the group consisting of a C₁-C₂₀ alkyl, phenyl, vinyl, methacryloxypropyl, aminopropyl, aminoethylaminopropyl, phenylaminopropyl, chloropropyl, mercaptopropyl, acryloxypropyl, 3-glycidoxypropyl, trifluoropropyl, heptadecafluorodecyl, and isocyanatopropyl group, and R″, which is a hydrolyzable functional group, is a C₁-C₂₀ alkoxy group or a halogen atom.

8. The organic photoreceptor of claim 7, wherein the product is obtained by coating the overcoat layer forming composition on the photosensitive layer and thermally treating the same.

9. The organic photoreceptor of claim 7, wherein the alcohol-soluble polymer is at least one selected from the group consisting of polyvinylbutyral, polyamide and polyurethane, and the amount thereof is in the range of 1 to 20 parts by weight based on 100 parts by weight of the organic silane compound represented by Formula 1.

10. The organic photoreceptor of claim 7, wherein the organic silane compound represented by Formula 1 is at least one selected from the group consisting of 3-glycidoxypropyl trimethoxysilane, methacryloxypropyltrimethoxysilane, aminopropyltrimethoxysilane, aminoethylaminopropyltrimethoxysilane, trifluoropropyltrimethoxysilane, heptadecafluorodecyltrimethoxysilane, isocyanatopropyltrimethoxysilane, 3-glycidoxypropyltriethoxysilane, methacryloxypropyltriethoxysilane, aminopropyltriethoxysilane, aminoethylaminopropyltriethoxysilane, trifluoropropyltriethoxysilane, heptadecafluorodecyltriethoxysilane, and isocyanatopropyltriethoxysilane.

11. The organic photoreceptor of claim 7, further comprising a hydrolysis catalyst in an amount of 5 to 20 parts by weight based on 100 parts by weight of the organic silane compound represented by Formula 1.

12. The organic photoreceptor of claim 11, wherein the hydrolysis catalyst is acetic acid.

13. The organic photoreceptor of claim 7, wherein the thermal treating is performed at a temperature in a range of 80 to 140° C.

14. The organic photoreceptor of claim 7, wherein the overcoat layer has a thickness of 0.1 to 10 μm.

15. The organic photoreceptor of claim 7, wherein the solvent is a cosolvent of at least one alcoholic solvent selected from the group consisting of methanol, ethanol, isopropanol and butanol, and water, and the amount thereof is in the range of 150 to 900 parts by weight based on 100 parts by weight of solid content of the overcoat layer forming composition, and the amount of water is in the range of 5 to 30 parts by weight based on 100 parts by weight of the alcoholic solvent.

16. The organic photoreceptor of claim 7, wherein the photosensitive layer is one of: a single layered structure having a charge generating material and a charge transport material, or a dual-layered structure having a charge generating layer made of a charge generating material and a charge transport layer made of a charge transport material.

17. The organic photoreceptor of claim 7, wherein the organic photoreceptor is used in an electrostatic imaging process with one of: dry and liquid toner development.

18. An organic photoreceptor cartridge of an image forming apparatus, the cartridge comprising:
an electrophotographic organic photoreceptor, comprising:
a conductive base;
a photosensitive layer formed on the conductive base; and
an overcoat layer formed on the photosensitive layer and having a product obtained by coating an overcoat layer forming composition comprising an organic silane compound represented by Formula 1, an alcohol-soluble polymer, and a solvent, and thermally treating the same: 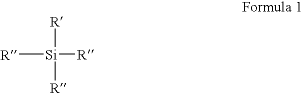
wherein R′ is at least one selected from the group consisting of a C₁-C₂₀ alkyl, phenyl, vinyl, methacryloxypropyl, aminopropyl, aminoethylaminopropyl, phenylaminopropyl, chloropropyl, mercaptopropyl, acryloxypropyl, 3-glycidoxypropyl, trifluoropropyl, heptadecafluorodecyl, and isocyanatopropyl group, and R″, which is a hydrolyzable functional group, is a C₁-C₂₀alkoxy group or a halogen atom; and
at least one of:
a charging device that charges the electrophotographic organic photoreceptor;
a developing device that develops an electrostatic latent image formed on the electrophotographic organic photoreceptor; and
a cleaning device which cleans a surface of the electrophotographic organic photoreceptor,
wherein the organic photoreceptor cartridge is attachable to and detachable from the image forming apparatus.

19. The cartridge of claim 18, further comprising a hydrolysis catalyst in an amount of 5 to 20 parts by weight based on 100 parts by weight of the organic silane compound represented by Formula 1.

20. An organic photoreceptor drum for an image forming apparatus, comprising:
a drum having an electrophotographic organic photoreceptor installed thereon, the electrophotographic organic photoreceptor,comprising:
a conductive base disposed on the drum;
a photosensitive layer formed on the conductive base; and
an overcoat layer formed on the photosensitive layer and having a product obtained by coating an overcoat layer forming composition comprising an organic silane compound represented by Formula 1, an alcohol-soluble polymer, and a solvent, and thermally treating the same: 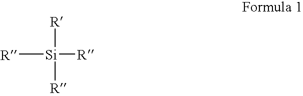
wherein R′ is at least one selected from the group consisting of a C₁-C₂₀ alkyl, phenyl, vinyl, methacryloxypropyl, aminopropyl, aminoethylaminopropyl, phenylaminopropyl, chloropropyl, mercaptopropyl, acryloxypropyl, 3-glycidoxypropyl, trifluoropropyl, heptadecafluorodecyl, and isocyanatopropyl group, and R″, which is a hydrolyzable functional group, is a C₁-C₂₀alkoxy group or a halogen atom,
wherein the drum is attachable to and detachable from the image forming apparatus.

21. The drum of claim 20, further comprising a hydrolysis catalyst in an amount of 5 to 20 parts by weight based on 100 parts by weight of the organic silane compound represented by Formula 1.

22. An image forming apparatus comprising:
a photoreceptor unit comprising:
an electrophotographic organic photoreceptor comprising:
a conductive base;
a photosensitive layer formed on the conductive base; and
an overcoat layer formed on the photosensitive layer and having a product obtained by coating an overcoat layer forming composition comprising an organic silane compound represented by Formula 1, an alcohol-soluble polymer, and a solvent, and thermally treating the same: 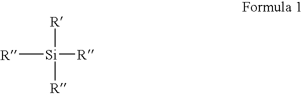
wherein R′ is at least one selected from the group consisting of a C₁-C₂₀ alkyl, phenyl, vinyl, methacryloxypropyl, aminopropyl, aminoethylaminopropyl, phenylaminopropyl, chloropropyl, mercaptopropyl, acryloxypropyl, 3-glycidoxypropyl, trifluoropropyl, heptadecafluorodecyl, and isocyanatopropyl group, and R″, which is a hydrolyzable functional group, is a C₁-C₂₀alkoxy group or a halogen atom;
a charging device which charges the photoreceptor;
an imagewise light irradiating device/developing device which irradiates the charged photoreceptor unit with imagewise light to form an electrostatic latent image on the photoreceptor unit;
a developing device which develops the electrostatic latent image with a toner to form a toner image on the photoreceptor unit; and
a transfer device which transfers the toner image onto a receiving material.

23. The image forming apparatus of claim 22, further comprising a hydrolysis catalyst in an amount of 5 to 20 parts by weight based on 100 parts by weight of the organic silane compound represented by Formula 1.
